(19) United States
(12) Patent Application Publication
(10) Pub. No.: US 2011/0159109 A1
(43) Pub. Date: Jun. 30, 2011

(54) TITANIA DISPERSION AND METHOD FOR MAKING

(75) Inventors: Byung-Yong Lee, Jenkintown, PA (US); Yury Gogotsi, Ivyland, PA (US)

(73) Assignee: DREXEL UNIVERSITY, PHILADELPHIA, PA (US)

(21) Appl. No.: 13/060,792

(22) PCT Filed: Sep. 2, 2009
(86) PCT No.: PCT/US09/55693

§ 371 Date: Feb. 25, 2011

Related U.S. Application Data
(60) Provisional application No. 61/190,783, filed on Sep. 2, 2008.

(51) Int. Cl. B01J 21/06; B01J 37/08; B01J 21/08; A01N 59/16; A01P 1/00

(52) U.S. Cl. 424/618; 502/350; 502/242

(57) ABSTRACT

A novel method for preparing a titania dispersion by blending two different titania dispersions synthesized by a solvothermal process and a hydrolysis process. The titania dispersion has a plurality of titania particles substantially uniformly dispersed therein and can be blended to provide a high concentration of titania with an anatase crystalline structure to provide the desired level of photocatalytic activity. The present invention also permits the preparation of transparent titania dispersions. The solution may be used for various decontamination and clean energy generation applications.

### BACKGROUND OF THE INVENTION

1. Field of Invention

The present invention is directed to a titania dispersion and a method for making it. It is envisioned that the titania dispersion may be particularly useful for clean energy generation and/or decontamination applications.

2. Brief Description of the Prior Art

Recently there has been growing interest in developing photocatalytic metal oxide dispersions for various sterilization and decontamination applications. Current sol gel and solvothermal methods for synthesizing photocatalytic dispersions, particularly titania dispersions and powders, are inefficient and are limited in their application and ability to break down undesirable organic compounds.

For example, titania powder may be synthesized using a conventional sol-gel process from the hydrolysis reaction of titania precursors. The process involves transforming a titanium dioxide liquid solution into a solid gel phase. The gel may be subsequently converted into powder upon drying and high temperature calcination. Such conventional sol-gel processes, however, require the addition of inorganic acid, which limits the growth of anatase structured crystals and therefore limits photocatalytic activity of the resultant titania product. As a result, the photocatalytic activity of titania sol-gels produced by hydrolysis may be insufficient for certain applications.

Other processes involve the deposition of titania precursors on a substrate followed by calcination to form titania in situ. These processes have the disadvantage that the surfaces on which the titania dispersion may be applied are limited to materials which can withstand high temperature calcinations, of about 500° C.-600° C., which is necessary to grow the titania film on the substrate after coating.

Additionally, few applications are capable of efficiently utilizing titania powders. For example, to treat noxious organic compounds in a wastewater treatment system, a significant amount of energy is required to make the titania powder buoyant and then separate and recover the photocatalytic particles after treatment for reuse. Moreover, to enable a wide variety of photocatalytic applications and to allow compatibility with different substrate surfaces, it would be beneficial to synthesize a liquid based colloid with uniformly dispersed anatase structure titania particles.

Samule et al. [Chem. Rev. 2007 107, 2891-2959] discloses a solvothermal process for preparing titania dispersions characterized by well-dispersed nano titania particles. The dispersion may be coated on a surface and may be capable of breaking apart volatile organic compounds. Although the solvothermal process produces a relatively high level of anatase titania thereby providing excellent photocatalytic activity, the solvothermal product suffers from the disadvantage that it does not provide a substantially uniform titania dispersion in the product thereby making its application difficult. Another disadvantage of the solvothermal process is that it is difficult to prepare suitable transparent or substantially transparent titania dispersions using this process.

There remains a need to develop a photocatalytic titania dispersion that contains a substantial proportion of anatase titania, has a substantially uniform dispersion of photocatalytic particles, provides sufficient photocatalytic activity when applied to a substrate and which may be transparent or substantially transparent, if desired.

### SUMMARY OF THE INVENTION

The invention is directed to a novel method for preparing a titania dispersion involving the steps of preparing a first titania dispersion from a composition comprising a titania precursor using a solvothermal process, preparing a second titania dispersion from a composition comprising a titania precursor by hydrolysis, and blending the first and second titania dispersions.

In another aspect, the invention is directed to a method for using the titania dispersion prepared by the process of the present invention to coat a substrate.

In a third aspect, the invention is directed to a titania dispersion wherein the titania particles are substantially uniformly dispersed and a substantial proportion of the titania has an anatase crystalline structure. The present invention provides the ability to prepare titania dispersions which, when applied, provide a high level of photocatalytic activity on a substrate. The present invention also allows the preparation of transparent or substantially transparent titania dispersions which can be applied, for example, to textile materials.

### BRIEF DESCRIPTION OF THE DRAWINGS

FIG. 1 is a diagram showing the antimicrobial filter application.

FIG. 2 is an x-ray diffraction graph of the tested titania dispersions.

FIG. 3 is a graph of UV-diffuse reflectance for the tested titania dispersions

FIG. 4 is a graph of methylene blue dye conversion percentage as a function of time.

FIG. 5 is an illustration of the test protocol employed in Example 7.

### DETAILED DESCRIPTION OF THE PREFERRED EMBODIMENTS

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other apparatuses and methods. Before explaining the disclosed embodiments of the present invention in detail, it is to be understood that the invention is not limited in its application to the details of any particular embodiment shown. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

It must be noted that as used herein and in the appended claims, the singular forms “a”, “an”, and “the” include plural references unless the context clearly dictates otherwise. As well, the terms “a” (or “an”), “one or more” and “at least one” can be used interchangeably herein. It is also to be noted that the terms “comprising”, “including”, and “having” can be used interchangeably.

The present invention is directed to the preparation of a titania dispersion having enhanced anatase crystallinity and substantially uniform titania dispersion. The dispersion may be prepared in a three step process that involves a first solvothermal preparation of titania particles, a second preparation of titania particles by hydrolysis and a subsequent step of blending the titania particles made by the solvothermal and hydrolysis processes. The solvothermal process provides a higher degree of anatase crystallinity and a higher concentration of the titania. In contrast, the hydrolysis process provides a more uniform particulate dispersion. In an exemplary embodiment, the invention is directed to a novel method for synthesizing a transparent and photocatalytic titania dispersion that is characterized by substantially uniformly dispersed nanometer titania particles having anatase crystalline structures.

### The Solvothermal Process

The solvothermal step of the present invention is designed to effectively proprogate anatase structure titania particles. Solvothermal preparation of titania is known and various solvothermal processes are described in, “Titanium Dioxide Nanomaterials: Synthesis, Properties, Modification and Applications,” Chen, Xiaobo and Mao, Samuel S., Chem. Rev., 2007, 107, 2891-2959, the disclosure of which is hereby incorporated by reference for the discussion of the production of titania nanomaterials by solvothermal processes.

The solvothermal step of the present invention involves preparing a solution of a titania precursor in a suitable solvent, such as non-aqueous polar solvent or mixtures of non-aqueous polar solvents. In order to enhance visible light efficiency, metal ions such as Fe³⁺, Cr³⁺, In³⁺, W⁶⁺, Nb⁵⁺, could be introduced as dopants into TiO₂ structure. Also, metal or metal oxides of Pt, Ru, Ni, Cu, Fe, could be impregnated. Therefore, the precursors for these materials, for example, platinum tetrachloride (PtCl₄), nickel nitrate, etc. may also be included in the solution. Any titania precursor or titania precursor complex may be incorporated in the solution. In an exemplary embodiment, the titania precursor and the synthesized titania dispersion may have photocatalytic properties. For example, the titania precursors, such as titanium isopropoxide, titanium butoxide, and other titanium alkoxides, titanium chloride, titanium nitrate, titanium sulfate, titanium amino oxylate, titanium trichloride, tetrabutoxytitanate, titanium tetraethoxide or a combination thereof, may be used to synthesize photocatalytic titanias.

The method is capable of synthesizing a nontoxic, water insoluble, highly oxidizing, UV and/or visible light activated photocatalytic titania particles. In an exemplary embodiment, the titania precursor may be present in the solution in an amount less than about 20% by weight of the solution, more preferably in an amount of about 1% to about 10% by weight of the solution.

Additional compounds, such as acids, bases or combinations thereof, may be added to the titania precursor solution to adjust the pH. In an exemplary embodiment, the pH of the mixture is sufficiently low to break down the titania particles, thereby producing small titania particles. The added compound may be used to establish a pH level equal to or less than about 6, preferably, about 1-6, more preferably, equal to or less than about 4, and most preferably, about 2-4. In an exemplary embodiment, the compound may be any inorganic acid, such as nitric acid, hydrochloric acid, sulfuric acid orthophosphoric acid, perchloric acid or organic acid such as acetic acid, pentanoic acid, butanoic acid, propanoic acid, oleic acid, carboxylic acid, linoleic acid or a combination thereof.

Additives may be optionally included in the mixture. In an exemplary embodiment, the additives may enhance antimicrobial activity of the dispersion. For example, silver precursors or other antimicrobial agents may be added to the mixture. The commonly used Ag precursor: silver nitrate, silver chloride. Also, small amounts (usually below 3 wt % of formed TiO₂ as a co-catalyst) of ZnO, ZrO₂, WO, CaO, MgO, FeO, Fe₂O₃, V₂O₅, Mn₂O₃, Al₂O₃, NiO, CuO, SiO₂, and metals having anti-bacterial properties such as Ag, Zn, Cu could be added. However, in that case, there may be some color change in opaque slurry.

Optionally, the mixture may also include any binding agent capable of facilitating or enhancing the binding or application of the synthesized titania dispersion to any desired surface or substrate. Preferably, the binding agent may be stable up to temperatures of at least about 200° C. More preferably, the binding agent may be either hydrophilic or may have a hydrophilic functional group. The binding agent may alternatively be added to the metal oxide dispersion. Also, SiO₂ formed with TiO₂ may act as a dopant to enhance photocatalytic activity at low energy light region (visible light comparing UV light) as well as enhance thermal stability. Most preferably, the binding agent facilitates the uniform dispersion of titania particles in a dispersion and/or uniform deposition of the titania dispersion on a substrate. In an exemplary embodiment, the binding agent may include at least one silica compound or precursor, such as tetraethyl orthosilicate (TEOS) or tetramethyl orthosilicate (TMOS), tetra-n-propoxysilane, tetra-n-butoxysilane, and tetrakis(2-mehoxyethoxy) silane, and organoalkoxysilanes such as methyltriethoxysilane, methyltrimethoxysilane, methyl tri-n-propoxysilane, phenyltriethoxysilane, vinyltriethoxysilane.

The binding material is preferably acidic and thus, may contain, for example, an inorganic acid. The binding agent may be capable of facilitating coupling without further modifying the surface or substrate to be coated with the titania dispersion.

Subsequently, the titania precursor solution may be stirred and simultaneously heated. Preferably, the solution is heated to a temperature of about less than 200° C., more preferably, about 150° C. to about 200° C., and most preferably about 150° C. to about 170° C. and is prepared under a pressure of about 10 atmospheres to about 20 atmospheres, preferably about 10 atmospheres to about 17 atmospheres for less than about 5 hours, more preferably about 2 hours to about 3 hours. Temperatures and pressures below this range are insufficient to induce chemical interaction, and temperatures and pressures above this range cause large particle coagulation and increase the risk of explosion. From this pressurized heating step, titania particulates may be precipitated in the titania precursor solution. No additional calcination step is necessary to produce the titania.

In an exemplary embodiment, the resultant product contains from about 1% to about 15% by weight of titania particles, based on the total weight of the reaction mixture, more preferably in an amount of about 0.3 wt % to about 5 wt %, based on the total weight of the reaction mixtures. Notably, the synthesized product has a high concentration of titania, and an increased crystallinity and Brunauer-Emmett-Teller (BET) specific surface area. The degree of crystallinity may be varied by adjusting the pH of the solution and/or the reaction temperature and pressure of the solvothermal reaction. In an exemplary embodiment, the solvothermal synthesis may produce fine nanosized titania particles of from about 2 nm to about 100 nm, more preferably, from about 5 nm to about 50 nm, and, most preferably, from about 10 nm to about 30 nm. Additionally, due to the added binder material, the solution may readily adhere to any surface or substrate.

### The Hydrolysis Method

It has been found necessary to improve upon the dispersion of the titania prepared by a solvothermal process. The present invention achieves this goal by conducting a second synthesis of titania by hydrolysis and then combining the hydrolysis product with the solvothermal product. Thus, the present invention also requires the step of synthesizing titania particles by hydrolysis of at least one titania precursor in solution. The production of titania by hydrolysis is also known and various hydrolysis processes, also referred to as hydrothermal processes, are described in, “Titanium Dioxide Nanomaterials: Synthesis, Properties, Modification and Applications,” Chen, Xiaobo and Mao, Samuel S., Chem. Rev., 2007, 107, 2891-2959, the disclosure of which is hereby incorporated by reference for the discussion of the production of titania nanomaterials by hydrothermal processes.

In the hydrolysis step, a solution is prepared from water and a titania precursor. Any titania precursor or titania precursor complex may be incorporated in the solution. In an exemplary embodiment, the titania precursor and the synthesized titania may have photocatalytic properties. For example, the titania precursors, such as titanium isopropoxide, titanium alkoxide, titanium chloride, titanium nitrate, titanium sulfate, titanium amino oxylate, titanium isoproxide or a combination thereof, may be used to synthesize photocatalytic titania. The hydrolysis step is also capable of synthesizing a nontoxic, water insoluble, highly oxidizing, UV and/or visible light activated photocatalytic titania.

In an exemplary embodiment, the titania precursor may be present in the solution in an amount less than about 20% by weight of the solution, more preferably in an amount of about 3% to about 10% by weight of the solution.

If necessary, deionized water may be added to the mixture to initiate hydrolysis and functions to maintain a dispersion of the titania photocatalyst. In an exemplary embodiment, water is present in an amount of about 50% to about 80% by weight of the solution, more preferably in an amount of about 65% to about 75% by weight of the solution.

Polar solvents may optionally be added to the titania precursor prior to hydrolysis. Any polar solvents capable of improving the dispersion of the titania particles may be added. In an exemplary embodiment, the polar solvent may be an organic, non-aqueous solvent. Preferably, the polar solvent may include ethyl alcohol, isopropyl alcohol, methyl alcohol, acetone, dichloromethane, tetrahydrofuran, ethylacetate, ethers, demethylformamide or a combination thereof.

Additional compounds, such as acids, bases or combinations thereof, may be added to the mixture to control the pH level of the mixture. In an exemplary embodiment, the pH of the mixture is sufficiently low to dissolve or break down the titania particles, thereby producing small titania particles. The added compound may be used to establish a pH level equal to or less than about 6, preferably, about 1-6, more preferably, equal to or less than about 4, and most preferably, about 2-5. In an exemplary embodiment, the compound may be any inorganic acid, such as nitric acid, hydrochloric acid, sulfuric acid orthophosphoric acid, perchloric acid or an organic acid such as acetic acid, pentanoic acid, butanoic acid, propanoic acid, oleic acid, carboxylic acid, linoleic acid or a combination thereof.

Optionally, the mixture may also contain various additives such as binder materials and chelating agents. In an exemplary embodiment, the mixture may include an additive, such as a chelating agent, which may function to reduce titania particle size, enhance dispersion stability, improve solubility, and induce catalytic action, and/or render the product transparent. Preferably, the chelating agent may include acetylacetone, ethylacetoacetate, oxalic acid, pentamethylene glycol (1,5-pentanediol), phosphonic acid, gluconic acid, diacetone alcohol, amino acids, butanedioic acid or combinations thereof. Usually, the added amount of chelating agent is within a molar ratio of 0.01-1 of chelating agent to titanium precursor, and more preferably a molar ration of 0.01-0.3 of chelating agent to titanium precursor.

The solution may be subsequently reacted at a temperature of about 60° C. to about 150° C., more preferably in an amount of about 70° C. to about 100° C. for about 6 hours to about 15 hours, more preferably for about 9 hours to about 13 hours. The mixture may then be subsequently agitated and cooled to about room temperature, to produce titania by hydrolysis of the titania precursor.

The resultant titania containing product contains from about 5% to about 20% by weight of titania, based on the total weight of the reaction mixture, more preferably in about 8% to about 15% by weight of titania, based on the total weight of the reaction mixture. Notably, the titania particles are uniformly dispersed and may be easily applied to any substrate surface. In an exemplary embodiment, the resulting titania particles may be nanosized, preferably having a diameter of from about 5 nm to about 50 nm, more preferably, having a diameter of from about 10 nm to about 30 nm. Additionally, the reaction product may be transparent, or alternatively may have any color, to enable various coating applications.

### Combining the Solvothermal and Hydrolysis Titania Dispersions

The resulting titania dispersions produced by the solvothermal process and hydrolysis process are subsequently blended together to produce a titania dispersion characterized by both a high degree of anatase crystalline structure as well as a substantially uniform dispersion of titania particles. In an exemplary embodiment, the titania dispersions synthesized by the solvothermal process and the hydrolysis process may be blended in a ratio of about 10:1 to about 1:2, more preferably, about 5:1 to about 2:1.

Optionally, water may be added to this mixture in order to improve the appearance, manufacture and application of the titania dispersion. After mixing, the dispersion may optionally be agitated. The synthesized titania dispersion is advantageous because it has a stable and uniformly dispersed high concentration of anatase crystalline titania particles. Furthermore, the dispersion may be photocatalytic, transparent and have a high binding affinity. In an exemplary embodiment, the titania colloid is an environmentally friendly, easily manufactured, inexpensive, highly photoactive uniform dispersion of nanosized titania particles in a transparent dispersion that may be activated under visible or ultra violet light.

The blended titania dispersion may then be applied to a substrate using any conventional means, including coating, such as spray coating, dip coating, spin coating, CVD (chemical vapor deposition), PVD (physical vapor deposition), electrostatic coating. The dispersion may be applied to any substrate surface, including both solid as well as porous membranes, such as fabrics and textiles. Alternatively, the titania dispersion may be incorporated in a liquid based or viscous medium, such as concrete, that may be used for construction or otherwise fabricate a structure.

In view of these advantages, the novel titania dispersion of the present invention, characterized by its high photocatalytic activity, stability and superior particle dispersion, may be used for a wide variety of applications. In one embodiment, it is envisioned that the highly oxidant solution may be used for clean energy generation by splitting water to produce hydrogen and oxygen.

Alternatively, it may be used for various decontamination applications. For example, the solution may enable environmentally safe oxidization of volatile organic compounds, malodorous materials, harmful gas emissions and other environmental pollutants from various sources, including vehicles as well as industrial plants. The photocatalytic solution may be used to sterilize, decompose, decontaminate and/or purify harmful or malodorous materials in any medium, including any structural surface, in the air and/or in a liquid using visible light and/or ultraviolet light irradiation. Therefore, the solution may be used decontaminate glass, tile, and metal surfaces as well as purify water and air. The solution may be directly placed on a substrate surface or on a contaminant to begin decontamination upon exposure to ultraviolet light or visible light. Alternatively, the solution may be incorporated in a paint, coating, or liquid mixture which is then applied to another substrate to be decontaminated. For example, the titania photocatalyst may be mixed with concrete or paint to oxidize nitrogen oxides (NOx) or sulfur oxides (SOx), which cause acid rain. Air pollutants may therefore be removed by coating or constructing roads and buildings with paints and/or coatings containing photocatalytic titania particles. Such coatings may also provide anti-fogging applications.

Additionally, the solution may also enable antimicrobial, namely antifungal, antimicrobial or antiviral, and other biological decontamination and sterilization applications, by light irradiation. In an exemplary embodiment, the photocatalytic antimicrobial solution may be particularly useful for constructing filtration systems, such as masks. In an exemplary embodiment, the solution may be coated on or incorporated in a nanofibrous matrix capable of fine filtration. Preferably, the matrix may be a textile or fabric capable of containing or filter out undesirable particles and pollutants. Alternatively, the solution may be coated on any surface to create a self-cleaning sterile surface area, which may be useful for hospitals, pharmaceutical plants, food preparation areas, waste collection areas, waste treatment plants, and other areas requiring germ control.

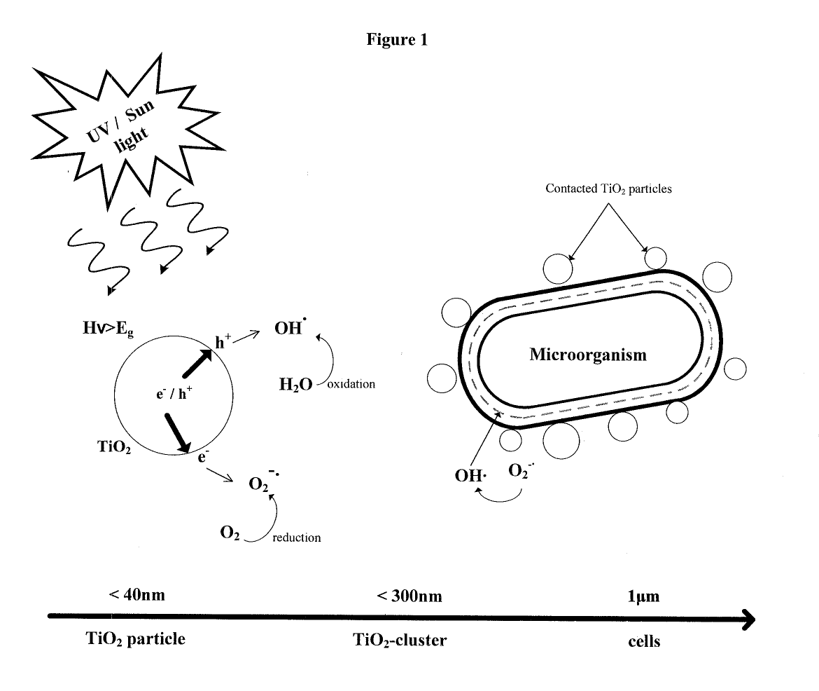

In an exemplary embodiment, the invention may be a photocatalytic titania dispersion coated on a substrate having a large specific surface area for antimicrobial activity. The photocatalytic titania particles may function to contain, inhibit or render ineffective bacteria, viruses such as influenza and rhinoviruses and other microorganisms. When the photocatalytic titania is illuminated by visible or ultra violet light having a higher energy than its band gaps, the valence electrons in the photocatalytic titania will excite to the conduction band, and the electrons and hole pairs will form on the surface and bulk inside of the photocatalyst. These electron and hole pairs generate oxygen radicals, O²⁻, and hydroxyl radicals, OH⁻, after combining oxygen and water, respectively. Because these chemical species are unstable, when the organic compounds contact the surface of the photocatalyst, it will combine with O²⁻ and OH⁻, respectively, and turn into carbon dioxide (CO₂) and water (H₂O). Through the reaction, the photocatalytic titania is able to decompose organic materials, such as odorous molecules, bacteria, viruses and other toxic or harmful microorganisms, in the air, on a substrate surface or in a liquid medium. As shown in FIG. 1, the antimicrobial activity of the photocatalyst involves oxidative damage of the cell wall where the photocatalytic titania contacts the microorganism. Upon penetration of the cell wall, the photocatalytic titania may gain access to and enable photooxidation of intracellular components, thereby accelerating cell death.

### EXAMPLES

### Example 1

In one embodiment, a titania dispersion of the present invention may be synthesized by mixing two titania dispersions prepared by a solvothermal process and by hydrolysis as follows.

During the solvothermal process, a mixture was prepared by adding about 19 g of a 67% concentrated nitric acid compound, and about 63 g of deionized water to about 3 L of a 95% concentrated ethyl alcohol compound. The mixture was agitated while the components were added. About 100 g of a 99.9% concentrated titanium tetraisopropoxide (TTIP) was then added drop by drop to the mixture, comprising about 1% by weight of the solution, and the mixture was stirred for over 2 hours to induce hydrolysis.

After mixing, the solution was then pressure sealed in an autoclave having a magnetic stirrer as well as a gauge and means for controlling temperature and pressure. The rotational speed of magnetic stirrer was set to 1,000 rpm, and autoclave was programmed to heat the solution to about 170° C. at a rate of about 5° C./min. The reactor temperature was maintained at about 170° C. for about 3 hours, and the pressure within the autoclave was maintained at about 16 atmospheres. The reactor was subsequently cool down to ambient room temperature, and the resulting ivory colored titania dispersion was removed.

During hydrolysis, about 1 kg of deionized water was poured into a 5 L vessel. A mixture of about 177.65 g of a 99.9% concentration of tetraisopropoxide (TTIP) and about 65 g of a 99% concentration of acetylacetone was added drop by drop to the water and agitated for over 30 min to prepare the mixture for hydrolysis. Acetylacetone was added as a chelating agent to control the hydrolysis reaction and to suppress particle agglomeration and growth. The reaction temperature was controlled by a heating mantle/heating jacket and set to about 90° C. After agitating for about 2 hours, about 9.8 g of a 67% concentrated nitric acid solution was added to the solution and stirred for about 2 hours. The reaction mixture was then cooled to ambient room temperature while stirring for about 12 hours to synthesize a yellowish titania dispersion.

The titania slurries produced by the solvothermal process and hydrolysis were then blended with deionized water in a ratio of about 5:1:4 by weight and agitated vigorously to produce a transparent and uniformly dispersed titania photocatalyst dispersion.

### Example 2

In one embodiment, a titania dispersion of the present invention may be synthesized by mixing two titania dispersions prepared by a solvothermal process and by hydrolysis as follows.

During the solvothermal process, a mixture was prepared by adding about 25 g of a 67% concentrated nitric acid compound and about 246 g of deionized water to about 3 L of 99% concentrated isopropanol. The mixture was agitated while the components were added. About 200 g of a 99.9% concentrated titanium tetraisopropoxide (TTIP) was then added drop by drop to the mixture, comprising 2% by weight of the solution, and the mixture was stirred for over 2 hours to induce hydrolysis.

After mixing, the solution was then pressure sealed in an autoclave having a magnetic stirrer as well as a gauge and means for controlling temperature and pressure. The rotational speed of magnetic stirrer was set to 1,000 rpm, and autoclave was programmed to heat the solution to about 160° C. at a rate of about 5° C./min. The reactor temperature was maintained at about 160° C. for about 3 hours, and the pressure within the autoclave was maintained at about 15 atm. The reactor was subsequently cool down to ambient room temperature, and the resulting white colored titania dispersion was removed.

During hydrolysis, 1 kg of deionized water was poured into a 5 L vessel. About 355.3 g of a 99.9% concentration of tetraisopropoxide (TTIP) was added drop by drop to the water and agitated for over 30 min to prepare the mixture for hydrolysis. About 50 g of a 98% concentrated oxalic acid compound was added as a chelating agent to control the hydrolysis reaction and to suppress particle agglomeration and growth. The reaction temperature was controlled by a heating mantle/heating jacket and set to about 90° C. After agitating for about 2 hours, about 6.3 g of a 67% concentrated nitric acid was added to the solution and stirred for about 2 hours. The reaction mixture was then cooled to ambient room temperature while stirring for about 12 hours to synthesize the titania dispersion.

The titania slurries produced by the solvothermal and hydrolysis steps were then blended with deionized water in a ratio of about 2:1:5 by weight and agitated vigorously to produce a titania photocatalyst dispersion.

### Example 3

In one embodiment, a titania dispersion of the present invention may be synthesized by mixing two titania dispersions prepared by a solvothermal process and by hydrolysis as follows.

During the solvothermal process, about 63 g of deionized water was added to about 1.5 L of a 95% concentrated ethyl alcohol solution, and the mixture was stirred.

A second mixture of about 22 grams of deionized water, about 150 g of ethyl alcohol and about 14 g of a 5% concentrated hydrochloric acid was added drop by drop to a vessel containing another mixture of about 61 g of tetramethyl orthosilicate (TMOS), about 500 g of ethyl alcohol and about 8.9 g of 5 wt % dilute phenolic resin in alcohol. This solution was agitated for over 30 minutes.

The two mixtures were subsequently mixed together and agitated. A mixture of about 100 g of a 99.9% concentrated titanium tetraisopropoxide (TTIP) and about 500 g ethyl alcohol was also added drop by drop to the mixture. A 67% concentrated nitric acid solution was added to adjust the pH level of the solution to about 2-3. The final mixture was stirred for over 2 hours to induce hydrolysis.

After mixing, the solution was then pressure sealed in an autoclave having a magnetic stirrer as well as a gauge and means for controlling temperature and pressure. The rotational speed of magnetic stirrer was set to 1,000 rpm, and autoclave was programmed to heat the solution to about 160° C. at a rate of about 5° C./min. The reactor temperature was maintained at about 160° C. for about 3 hours, and the pressure within the autoclave was maintained at about 17 atmospheres. The reactor was subsequently cool down to ambient room temperature, and the resulting white colored titania dispersion was removed.

During hydrolysis, about 355.3 g of a 99.9% concentration of tetraisopropoxide (TTIP) was poured into a 5 L reactor filled with about 1 kg of deionized water. The mixture was agitated for over 30 minutes to prepare the mixture for hydrolysis. About 50 g of a 98% concentrated oxalic acid compound was added as a chelating agent to control the hydrolysis reaction and to suppress particle agglomeration and growth. The reaction temperature was controlled by a heating mantle/heating jacket and set to about 90° C. After agitating for about 2 hours, about 6.3 g of a 67% concentrated nitric acid was added to the solution and stirred for about 2 hours. The reaction mixture was then cooled to ambient room temperature while stirring for about 12 hours to synthesize the titania dispersion.

The titania dispersions produced by the solvothermal process and hydrolysis were then blended with deionized water in a ratio of about 2:1:3 by weight and agitated vigorously to produce a titania photocatalyst dispersion.

### Example 4

In one embodiment, the dispersion of the present invention may be synthesized by mixing two titania dispersions prepared by a solvothermal process and by hydrolysis as follows.

During the solvothermal process, a mixture was prepared by adding about 26 g of a 67% concentrated nitric acid compound, about 2 g of a 99.9% concentrated silver nitrate compound and about 95 g of deionized water to about 3 L of a 95% concentrated ethyl alcohol. The mixture was agitated while the components were added. About 150 g of a 99.9% concentrated titanium tetraisopropoxide (TTIP) was then added drop by drop to the mixture, comprising 1.5% by weight of the solution, and the mixture was stirred for over 2 hours to induce hydrolysis.

After mixing, the solution was then pressure sealed in an autoclave having a magnetic stirrer as well as a gauge and means for controlling temperature and pressure. The rotational speed of magnetic stirrer was set to 1,000 rpm, and autoclave was programmed to heat the solution to about 160° C. at a rate of about 5° C./min. The reactor temperature was maintained at about 160° C. for about 3 hours, and the pressure within the autoclave was maintained at about 16 atm. The reactor was subsequently cool down to ambient room temperature, and the resulting gray colored titania dispersion was removed.

During hydrolysis, about 1 kg of deionized water was poured into a 5 L reactor. A mixture of about 177.7 g of a 99.9% concentration of tetraisopropoxide (TTIP) and about 33.3 g of a 96% concentration of pentamethylene glycol was added drop by drop to the water and agitated for over 30 min to prepare the mixture for hydrolysis. Acetylacetone was added as a chelating agent to control the hydrolysis reaction and to suppress particle agglomeration and growth. The reaction temperature was controlled by a heating mantle/heating jacket and set to about 90° C. After agitating for about 2 hours, about 8.1 g of a 67% concentrated nitric acid solution was added to the solution and stirred for about 2 hours. The reaction mixture was then cool to ambient room temperature while stirring for about 12 hours to synthesize the titania dispersion.

The titania slurries produced by the solvothermal process and hydrolysis were then blended with deionized water in a ratio of about 3:1:5 by weight and agitated vigorously to produce a titania photocatalyst dispersion.

### Example 5

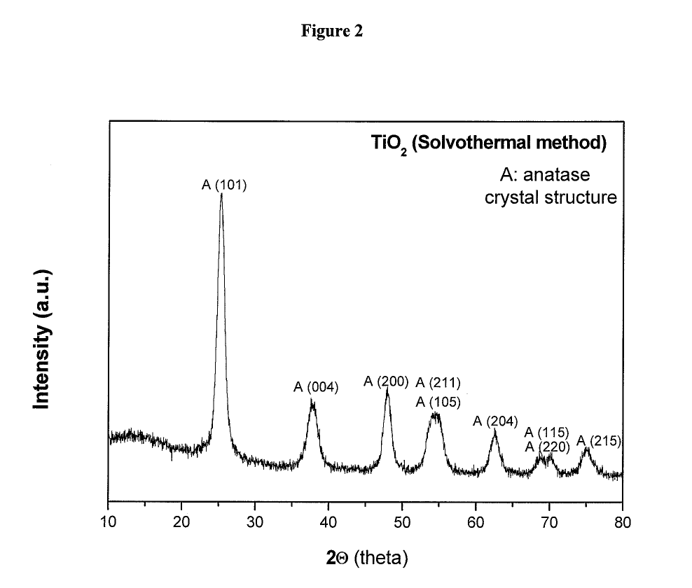

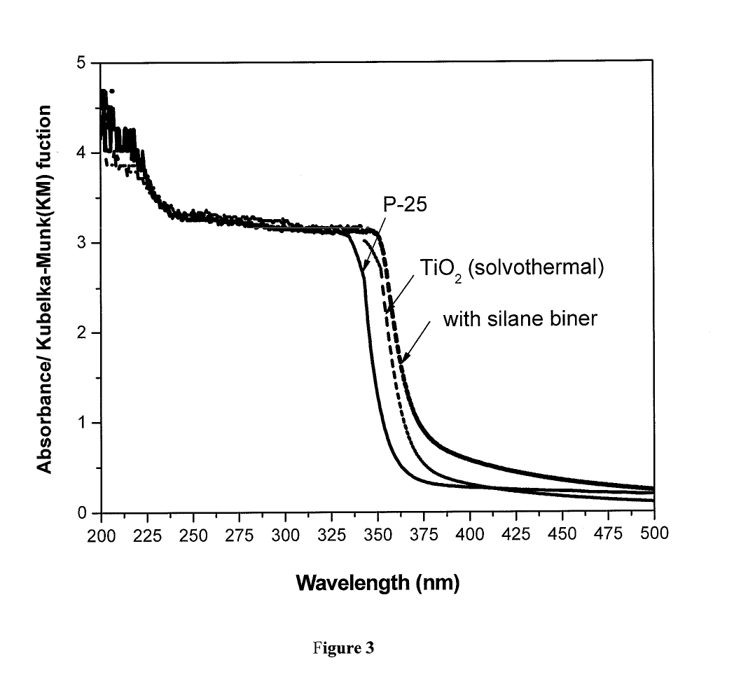

The morphologies of the synthesized titania dispersion of Example 1 was analyzed by X-ray diffraction. The titania particles of the synthesized dispersions were measured to be about 10 to 20 nm and were uniformly dispersed. X-ray diffraction analysis using nickel filtered Cu Kα radiation and examination of the diffraction peak anatase phase were also used to analyze the crystallinity of the titania dispersions. The X-ray diffraction pattern of the dispersions, as shown in FIG. 2, suggested that the synthesized titania particles were solely anatase crystalline in structure. Additionally, based on the X-ray diffraction pattern, the average particle size, estimated based on Equation 1, was about 10 nm, which corresponded to the SEM measurements.

$$d = \frac{0.89 λ}{β cos θ} \qquad Equation 1$$

where, λ=1.5418 Å (Cu Kα) and β is FWHM (full width at half maximum) at the diffraction angle of θ. FIG. 3 shows the absorbance measurements of the dispersions when irradiated with UV-visible spectrophotometer using a wavelength of about 200-500 nm. This figure demonstrates that the titania dispersion may be activated at or near wavelengths in the ultra violet and visible light range.

### Example 6

The photocatalytic activity of the titania dispersions synthesized in Examples 1-4 were analyzed by testing their deodorization, anti-fungal, anti-bacterial and self-cleaning properties. The results demonstrated that titania dispersions of the present invention have a high photocatalytic activity.

### Deodorization Experiment

The level of photocatalytic activity of the titania dispersions was measured by evaluating deodorization activity. To evaluate the deodorization properties of the titania dispersion of Example 1, the dispersion was tested with acetaldehyde, a malodorous volatile organic compound.

A 10×10 cm² glass plate was coated with a prepared titania dispersion and dried at about 70° C. to about 120° C. over a period of about 2 hours. The plate was subsequently cool to ambient room temperature. Prior to exposure to the acetaldehyde, the titania coated plate was illuminated with UV-A light having a light intensity of about 1.0 mW/cm² over a period of about 3 hours. The titania coated plate was then placed within a 5 L-Tedlar™ bag, which was slit open. The bag was then tightly sealed using a heat sealer. Subsequently, a vacuum pump was used to extract air of inside from an opening of Tedlar™ bag; thereafter the opening was closed.

A gaseous mixture containing about 100 ppm of acetaldehyde was then collected and introduced into the Tedlar™ bag. The Tedlar™ bag containing the titania coated plate and acetaldehyde gas was subsequently exposed to UV-light at an intensity of about 1 mW/cm² over a period of about 2 hours using a 40 W black light blue lamp. The gas inside the Tedlar™ bag was monitored every 10 min after light irradiation, and the concentration of the acetaldehyde gas inside the Tedlar™ bag was measured using a gas chromatography equipped Flame ionized detector.

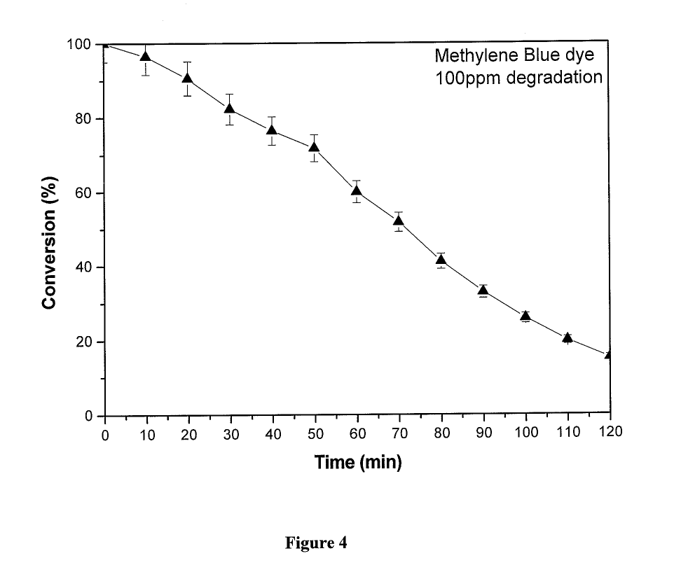

FIG. 4 shows the decomposition rate of the acetaldehyde gas inside of Tedlar™ bag over a period of 2 hours in 10 min intervals. According to the figure, the deodorization efficiency increase with UV light irradiation time. After 2 hours, the concentration of acetaldehyde steadily decreased to below 20 ppm. Therefore, the experiment demonstrated that the titania dispersions have superior photocatalytic activity in view of its ability to break down acetaldehyde gas.

### Anti-Fungal Experiment

The level of photocatalytic activity of the titania dispersions was measured by evaluating anti-fungal activity. To evaluate the anti-fungal properties of the titania dispersion of Example 1, the dispersion was tested by exposure to a fungi culture.

Several coats of the titania dispersion of Example 1 was applied to sets of 6 wallpaper sheets having a dimension of about 5×5 cm². The sheets were subsequently dried at about 60° C. for 30 min.

A fungi culture was also created using about 1 L of deionized water, about 3.0 g of ammonium nitrate (NH₄NO₃), about 1.0 g of kotassium dihydrogen phosphate (KDP, KH₂PO₄), about 0.5 g of magnesium sulfate (MgSO₄), about 0.25 g of potassium chloride (KCl), about 0.002 g of iron sulphate (FeSO₄.7H₂O), and about 25 g of agar. A 1.0 ml blended fungal spore suspension was then uniformly streaked on a plate, and the prepared titania coated sheet was placed in the center of the plate. 0.05 ml of the blended pore fungal suspension was again uniformly streaked on the plate. After covering, the plate was allowed to incubate for 14 days at a temperature of about 28±2° C. and humidity of over 95%.

The plates were monitored over the 14 day period according to a 3 tiered fungicide index that evaluates the ripeness of the agar fungi. A score of 3 represents that no amount of agar cultured fungus was observed on the titania coated sheet. A score of 2 represents that agar cultured fungus was observed on the titania coated sheet but did not exceed ⅓ of the titania coated sheet. A score of 1 represents that agar cultured fungus was observed on the titania coated sheet and exceed ⅓ of the titania coated sheet. After 4 weeks of incubation, every tested titania coated sheet was evaluated as having a fungicide index of 3. Therefore, the experiment demonstrated that the titania dispersions have superior photocatalytic activity in view of the highly effective fungicide activity.

### Antibacterial Experiment

The level of photocatalytic activity of the titania dispersions was measured by evaluating antibacterial activity. To evaluate the antibacterial properties of the titania dispersion of Example, the dispersion was tested by exposure to E. Coli.

The titania dispersion of Example 1 was coated on an array of plates. The titania coated plates were then sterilized by heating the plates to 150° C. for a 30 minute period.

A 10 ml E. Coli solution was incubated at a temperature of about 35° C. for about 24 hours. The E. Coli solution was then re-suspended in deionized water and diluted to a concentration of about 2×10⁵ colony forming unit (CFU)/ml. The diluted E. Coli solution was then dropped onto the titania coated plates and quickly covered with an air tight cover film.

The plates were irradiation under a 15 W black light blue UV lamp at an intensity of about 1.0 mW/cm² over a period of about 2 hours. The plates were then rinsed with 0.15 M saline solution to collect any surviving E. Coli. 1 ml of the collected E. Coli was, then, plated on a petri dish and cultured at a temperature of about 37° C. for a period of about 24 hours, and the surviving survival E. Coli were counted.

Before UV irradiation, colonies of E. Coli were visibly present. After UV irradiation, all traces of the cultivated E. Coli colonies were destroyed. Therefore, the experiment demonstrated that the titania dispersions have superior photocatalytic activity in view of the highly effective antibacterial activity.

### Self-Cleaning

The level of photocatalytic activity of the titania dispersions was measured by evaluating their self-cleaning capabilities. To evaluate the self-cleaning properties of the titania dispersion of Example 1, the dispersion was tested by evaluating their ability to degrade methylene blue (C₁₆H₁₈ClN₃S).

About 100 ml of each of the titania dispersion of Example 1 was blended with about 100 ml of methylene blue and then vigorously stirred in the dark for abut 1 hour using a magnetic stirrer. The dispersion, having an initial methylene blue concentration of about 3.2×10⁻⁴ mol/l, was then exposed to UV illumination. The dispersion was maintained at ambient room temperature and at a pH level of about 6, using sodium hydroxide. Degradation of methylene blue over time was then measured under this established environmental condition.

About 50 ml of the dispersion was then poured into a petri dish and irradiated using a 40 W black light blue UV-A lamp having a light intensity of about 1.0 mW/cm² for about 1 hour. The light intensity was controlled using an UV-radiometer (Konica Minolta UM-360). The degree of methylene blue degradation was observed over time with the naked eye.

Prior to exposure to UV light, the dispersion had a pervasive blue color. After UV irradiation, the dispersion was transparent and showed no blue coloration. Therefore, the experiment demonstrated that the titania dispersions have superior photocatalytic activity in view of their ability to degrade methylene blue.

### Example 7

### Preparation and Coating of Fabrics

TiO₂ colloidal solution was synthesized by a solvothermal process. Titanium tetraisopropoxide (99.9%, TTIP, Sigma Aldrich, USA) was used as a precursor for the synthesis of TiO₂ particles. The mixture was prepared by adding acetic acid, and 0.15 mol of TTIP to 1 L of isopropyl alcohol, and 1.2 mol of deionized water and nitric acid were added drop by drop to the mixture, comprising about 1% by weight of the solution. Then, the solution was put into an autoclave and heated to 170° C. for 3 hours. Water and 0.3 mol of nitric acid were then added to the solution. Next, silanol was added to the solution.

Tetramethylorthosilicate (99.9%, TMOS Sigma-Aldrich, USA), precursor, was added to ethanol. Then a mixture (1:1 v/v) of deionized water and ethanol was added for hydrolysis. Next, hydrochloric acid (37.5%) was added to adjust the pH to around 2. The solution was aged at room temperature for over 12 hours. Then the Ti-containing and Si-containing solutions were mixed, and blending of the TiO₂ and TMOS binder was controlled as 1.5:1 weight ratio. Next, TiO₂ powder was mixed in 500 ml of deionized water, respectively, and nitric acid was added to adjust pH around 3 of solution. Then the suspensions were sonicated for 30 minutes.

The mask fabric was washed with ethanol and deionized water solution (1:1 w/w) for 30 minutes, and dried in an oven at 70° C. The fabric was then dipped into the TiO₂-TMOS binder colloidal solutions for 30 minutes. The samples were dried in air at ambient temperature over 1 hour then heated at 80° C. for 20 minutes. The coated fabric samples were washed in deionized water again under sonication.

### Test Procedure

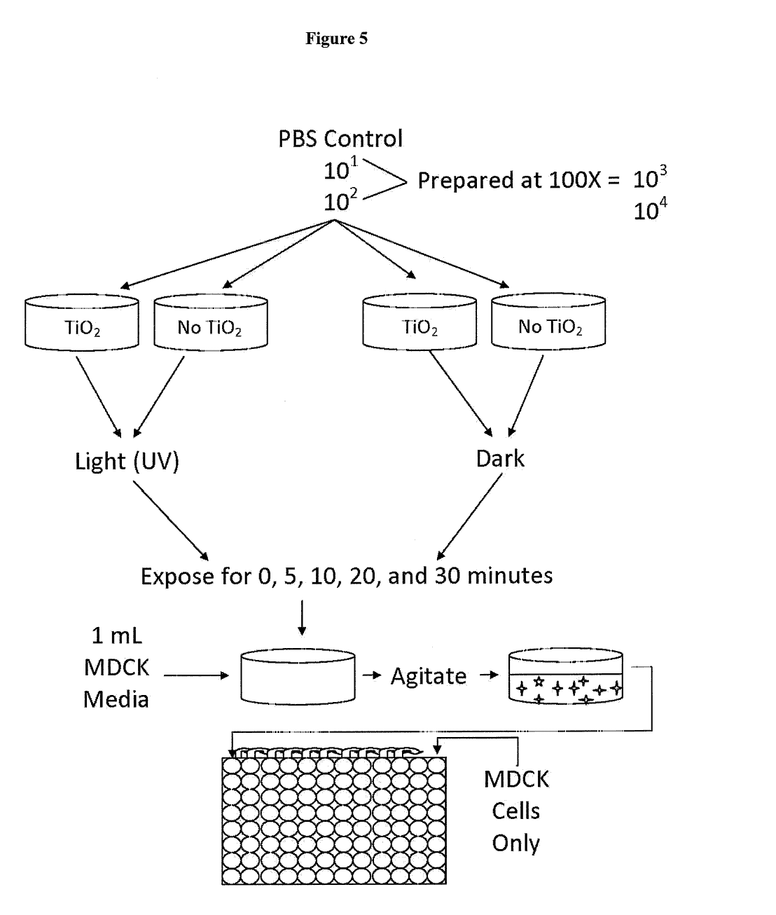

Titanium dioxide-treated and untreated control mask materials were exposed to a solution containing influenza A virus. The masks were then exposed to UVA light (400 nm-320 nm) for 0-30 minutes. The presence of residual live virus was then determined using a standard hemagglutination assay using Madin-Darby canine kidney (MDCK) cells. The test protocol is illustrated in FIG. 5.

Control and TiO₂ mask materials were cut into 1 cm² pieces. The appropriate virus solutions were prepared at 100 times the desired concentration. A 10 ul drop of the desired virus solution was placed onto both the control and TiO₂ mask materials. Two treatment groups were created: UV exposed groups, and non-UV exposed groups. A UVA (400 nm-320 nm) bulb fixed to the top of a sealed wooden box was employed as the light source. The groups were exposed to their respective treatments.

After their treatments, each sample was placed in 1 ml of MDCK media and agitated. The virus titers of the samples were then analyzed through the use of an MDCK assay. Samples were serially diluted across a microtiter plate and 2.5×10⁴ MDCK cells were added to all wells. After overnight incubation, media was aspirated fresh media containing TPCK-treated trypsin was added and the mixture was incubated for an additional 3 days. CRBC suspension was added and incubated for 1-3 hours. Agglutination patterns were recorded to calculate the 50% Tissue Culture Infectious Dose (TCID₅₀).

### Results

Tables 1A-1B show the effects of TiO₂ and UV light on influenza virus following low-dose virus exposure (Table 1A) and a high-dose virus exposure (Table 1B) over time, reported as TCID₅₀/mL.

TABLE 1A

| | |
|---|---|
| Control | TiO2-treated |
| Mask | Mask |

| Time (min.) | Dark | UV | Dark | UV |
|---|---|---|---|---|
| 0 | 7.74 | 7.74 | 6.34 | 6.34 |
| 5 | 6.34 | 5.64 | 4.95 | 5.65 |
| 10 | 5.65 | 7.04 | 3.55 | 4.95 |
| 20 | 8.44 | 6.34 | 4.95 | 0 |
| 30 | 0 | 0 | 0 | 0 |

TABLE 1B

| | |
|---|---|
| Control | TiO2-treated |
| Mask | Mask |

| Time (min.) | Dark | UV | Dark | UV |
|---|---|---|---|---|
| 0 | 9.14 | 9.14 | 9.84 | 9.84 |
| 5 | 8.44 | 7.04 | 9.14 | 9.14 |
| 10 | 9.14 | 10.54 | 8.44 | 7.74 |
| 20 | 9.84 | 10.54 | 8.44 | 0 |
| 30 | 0 | 0 | 0 | 0 |

These results indicate that a combination of TiO₂ and UV light exposure eliminate infectious influenza virus within 20 minutes of exposure compared to 30 minutes for the control mask and that infectious influenza virus was eliminated from all samples at 30 minutes.

The foregoing examples have been presented for the purpose of illustration and description and are not to be construed as limiting the scope of the invention in any way. The scope of the invention is to be determined from the claims appended hereto.

What is claimed is:

1. A method for preparing a titania dispersion comprising the steps of:
synthesizing a first titania dispersion from a solution containing at least one titania precursor by a solvothermal process;
synthesizing a second titania dispersion from a solution containing at least one titania precursor by hydrolysis; and
blending said first titania dispersion and said second titania dispersion.

2. The method of claim 1 wherein said blending step comprises blending said first titania dispersion and said second titania dispersion in a ratio of about 10:1 to about 1:2.

3. The method of claim 1 wherein said blending step comprises blending said first titania dispersion and said second titania dispersion in a ratio of about 5:1 to about 2:1.

4. The method of claim 1 wherein said blending step further comprises adding water to the blended titania dispersion.

5. The method of claim 1, wherein said titania precursor may be present in each said solution in an amount of about less than 20% by weight of the solution.

6. The method of claim 1, wherein at least one of the titania precursor solutions further comprises an antimicrobial compound.

7. The method of claim 6, wherein said antimicrobial compound is a silver precursor.

8. The method of claim 1, wherein one of the titania precursor solutions further comprises a binder material that facilitates binding of titania to a substrate.

9. The method of claim 8, wherein said binder material is a silica-containing material.

10. The method of claim 1, wherein said synthesis of said first titania dispersion by a solvothermal process comprises heating said first titania precursor solution to a temperature of from about 150° C. to about 200° C.

11. The method of claim 1, wherein said first titania precursor solution is a solution of titania precursor in a non-aqueous polar solvent.

12. The method of claim 11, wherein said polar solvent is selected from the group consisting of: ethyl alcohol, isopropyl alcohol, methyl alcohol and mixtures thereof.

13. The method of claim 1, wherein said second titania precursor solution further comprises a chelating agent.

14. The method of claim 13, wherein said chelating agent is selected from the group consisting of: acetylacetone, ethylacetoacetate, oxalic acid, pentamethylene glycol (1,5-pentanediol), phosphonic acid, gluconic acid, diacetone alcohol and mixtures thereof.

15. The method of claim 1, wherein said titania precursor is selected from the group consisting of: titanium ixopropoxide, titanium alkoxide, titanium chloride, titanium nitrate, titanium sulfate, titanium amino oxylate, titanium isoproxide and mixtures thereof.

16. The method of claim 1, wherein deionized water is present in said second titania precursor solution in an amount of from about 5% by weight to about 20% by weight, based on a total weight of the second titania precursor solution

17. The method of claim 1, further comprising the step of adjusting a pH of said titania precursor solutions to a pH of 2-6.

18. The method of claim 1, wherein said first and second titania dispersions are blended in a ratio which provides a transparent titania dispersion.

19. A titania dispersion prepared by the method of claim 1.

20. A transparent titania dispersion prepared by the method of claim 18.
